(19) United States
(12) Patent Application Publication
(10) Pub. No.: US 2011/0072304 A1
(43) Pub. Date: Mar. 24, 2011

(54) APPLICATION SERVER AND METHOD OF CONTROLLING OPERATION OF SAME

(75) Inventor: Kentaro WATANABE, Ashigarakami-gun (JP)

(73) Assignee: FUJIFILM Corporation, Tokyo (JP)

(21) Appl. No.: 12/888,806

(22) Filed: Sep. 23, 2010

(30) Foreign Application Priority Data
Sep. 24, 2009 (JP) 2009-218916

(51) Int. Cl. G06F 11/14; G06F 11/07

(52) U.S. Cl. 714/18; 714/55; 714/E11.024; 714/E11.131

(57) ABSTRACT

A mobile telephone accesses an application server and application software is launched in the server. The application software is run on the application server based upon instructions from the mobile telephone and the result is displayed on the mobile telephone. If the mobile telephone and application server are disconnected and a fixed period of time elapses, the application software that has been launched in the application server is terminated. Since the application server can be allocated to software launched by mobile telephones other than the above-mentioned mobile telephone, the application server can be utilized more efficiently.

### BACKGROUND OF THE INVENTION

1. Field of the Invention

This invention relates to an application server and to a method of controlling the operation thereof.

2. Description of the Related Art A thin client system narrows down the functions of a client computer, such as a mobile terminal, to functions such as display and communication with a server, with application software and files, etc., being managed by the server. While application software is launched by the server, communication takes place between the client computer and the server, operation is instructed by the client computer and processing is executed by the server based upon these instructions. The result of such processing by the server is transmitted to the client computer. Although the client computer and server communicate, there are instances where communication is severed. In order to prepare for such severance of communication, there is a technique whereby image information is preserved in the client computer and is not transmitted to the client computer at re-connection unless the image has changed (see the specification of Japanese Patent Application Laid-Open No. 2008-71092) and a technique that omits the labor of authentication at re-connection by having the server preserve information necessary for session establishment (see the specification of Japanese Patent Application Laid-Open No. 2005-63169).

A software application currently launched is maintained in the launched state by the server even in a case where communication between the client computer and server is severed. In a thin client system in which a number of mobile terminals access a server, the efficiency of server utilization is poor. Nevertheless, no consideration has been given to improving the efficiency of server utilization in such a system.

### SUMMARY OF THE INVENTION

Accordingly, an object of the present invention is to improve the efficiency of server utilization.

The present invention provides an application server a launching device (launching means), responsive to an application-software launch request transmitted from one mobile terminal among the number of mobile terminals, for launching application software whose launch has been requested; an image data transmitting device (image data transmitting means) for transmitting image data (a launch image, processing image, operation image), which represents an image of the application software launched by the launching device, to the one mobile terminal; an application software control device (application software control means) for controlling the application software, which has been launched by the launching device, so as to operate in accordance with application-software operating instruction data transmitted from the one mobile terminal owing to receipt at the mobile terminal of the image data transmitted from the image data transmitting device; a transmission control device (transmission control means) for controlling the image data transmitting device in such a manner that image data representing the image of the application software controlled by the application software control device is transmitted to the one mobile terminal; a disconnect determination device (disconnect determination means) for determining whether communication with the one mobile terminal has been severed; and a time-expiration determination device (time-expiration determination means) for determining whether a fixed period of time has expired from a moment at which the disconnect determination device determines that communication with the one mobile terminal has been severed; wherein in response to a determination by the time-expiration determination device that the fixed period of time has expired, the application software control device terminates the application software launched by the launching device.

The present invention also provides an operation control method suited to the above-described application software. Specifically, the present invention provides a method of controlling operation of application server which is capable of communicating with a number of mobile terminals and in which application software has been installed, the method comprising: launching application software, whose launch has been requested, in response to an application-software launch request transmitted from one mobile terminal among the number of mobile terminals; transmitting image data (a launch image, processing image, operation image), which represents an image of the application software launched, to the one mobile terminal; controlling the application software, which has been launched, so as to operate in accordance with application-software operating instruction data transmitted from the one mobile terminal owing to receipt at the mobile terminal of the image data transmitted; exercising control in such a manner that image data representing the image of the application software controlled is transmitted to the one mobile terminal; determining whether communication with the one mobile terminal has been severed; determining whether a fixed period of time has expired from a moment at which severance of communication with the one mobile terminal has been determined; and terminating the launched application software in response to a determination that the fixed length of time has expired.

In accordance with the present invention, application software is launched in an application server in response to a request from a mobile terminal. Image data representing the image of the launched application software is transmitted from the application server to the mobile terminal, and the image of the application software is displayed on the display screen of the mobile terminal. The user of the mobile terminal performs an operation using the image of the application software being displayed on the display screen and operating instruction data is transmitted from the mobile terminal to the application server. The application software runs in the application server in accordance with the operating instruction data and image data representing the result of this operation is transmitted from the application server to the mobile terminal. When communication between the mobile terminal and the application server is severed, whether a fixed period of time has elapsed from such severance is checked. If the fixed period of time has elapsed from severance, then the application software that has been launched is terminated. As a result, the application server can communicate with mobile terminals other than the one with which is was communicating and can launch application software. This makes possible more efficient utilization of the application server.

By way of example, in response to re-connection of the one mobile terminal and the application server before the fixed period of time expires from the moment at which the disconnect determination device determines that communication with the one mobile terminal has been severed, the image data transmitting device transmits the image data, which represents the image of the application software that has been launched by the launching device, to the one mobile terminal.

By way of example, in response to re-connection of the one mobile terminal and the application server and to issuance of a re-transmit request for image data, which represents the image of the application software that has been launched by the launching device, before the fixed period of time expires from the moment at which the disconnect determination device determines that communication with the one mobile terminal has been severed, the image data transmitting device transmits the image data, which represents the image of the application software that has been launched by the launching device, to the one mobile terminal, and in response to re-connection of the one mobile terminal and the application server and issuance of a re-launch request for the application software that has been launched by the launching device, before the fixed length of time expires from the moment at which the disconnect determination device determines that communication with the one mobile terminal has been severed, the image data transmitting device re-launches the application software that has been launched by the launching device and transmits the image data, which represents the image of the re-launched application software, to the one mobile terminal.

By way of example, the launching device launches a plurality of items of application software in response to launch requests for a plurality of items of application software transmitted from the one mobile terminal. Further, by way of example, the image data transmitting device transmits image data, which represents images of the plurality of items of application software launched by the launching device, to the one mobile terminal. Furthermore, by way of example, the application software control device controls application software, which has been operated at the one mobile terminal, among the items of application software that have been launched by the launching device, so as to operate in accordance with identification data, which identifies the application software operated at the one mobile terminal among the plurality of items of application software, and with operating instruction data, which instructs operation of the operated application software, transmitted from the one mobile terminal owing to receipt at the mobile terminal of the image data transmitted from the image data transmitting device. Further, by way of example, in response to re-connection of the one mobile terminal and the application server and issuance of a re-transmit request for image data, which represents the image of prescribed application software among the plurality of items of application software, before the fixed period of time expires from the moment at which the disconnect determination device determines that communication with the one mobile terminal has been severed, the image data transmitting device transmits the image data, which represents the image of the prescribed application software among the images of application software that have been launched by the launching device, to the one mobile terminal.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates an overview of a thin client system;

FIG. 2 is a block diagram illustrating the electrical configuration of an application server;

FIG. 3 illustrates an example of a table of applications currently launched;

FIGS. 4 to 6 are flowcharts illustrating processing executed by the thin client system;

FIG. 7 illustrates the relationship between an image displayed on a mobile telephone and software that has been launched in an application server;

FIGS. 8A, 8B, 8C and FIGS. 9A, 9B and 9c illustrate the relationship between images displayed on the mobile telephone and software that has been launched in the application server;

FIG. 10 illustrates an example of a table of applications currently launched;

FIG. 11 is a flowchart showing a portion of processing executed by the thin client system; and

FIG. 12 illustrates the relationship between an image displayed on a mobile telephone and software that has been launched in an application server.

### DESCRIPTION OF THE PREFERRED EMBODIMENTS

A preferred embodiment of the present invention will now be described with reference to the drawings.

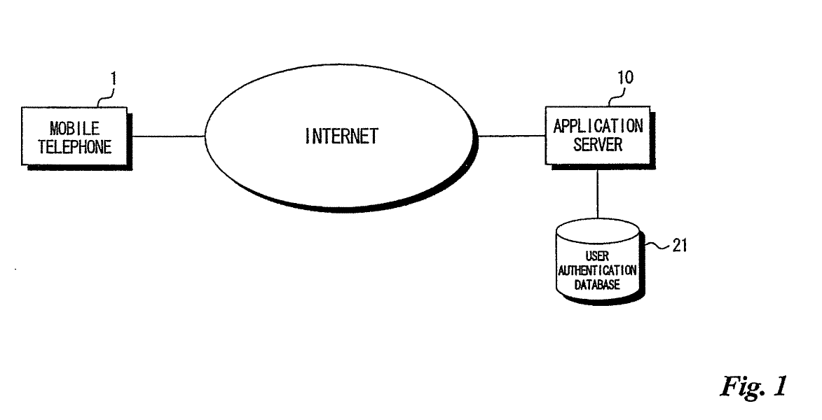

FIG. 1 illustrates an overview of a thin client system according to a preferred embodiment of the present invention.

The thin client system includes a mobile telephone (mobile terminal) 1 and an application server 10 capable of communicating via the Internet. Although only one mobile telephone 1 is shown in FIG. 1, a number of mobile telephones are capable of communicating with the application server 10 in actuality.

The thin client system according to this embodiment is such that the mobile telephone 1 and application server 10 communicate with each other, the application server 10 launches an application program, the mobile telephone 1 issues operating instructions, and the application server 10 performs operations conforming to these operating instructions and sends the mobile telephone 1 the result of processing the application program. Since the mobile telephone 1 need not run the application program and need only display an image indicating the result of processing the application program and perform such tasks as the issuance of the operating instructions, an application program can essentially be utilized even in the limited-capability mobile telephone 1. Naturally, it may be so arranged that the processing according to this embodiment is executed also in a mobile telephone (mobile terminal) that is capable of running application programs.

Connected to the application server 10 is a user authentication database 21 for authenticating users who can utilize the thin client system (application server 10). Stored in the user authentication database 21 is identification data identifying the users who are capable of utilizing the application server 10, and data identifying application software currently being used by the users.

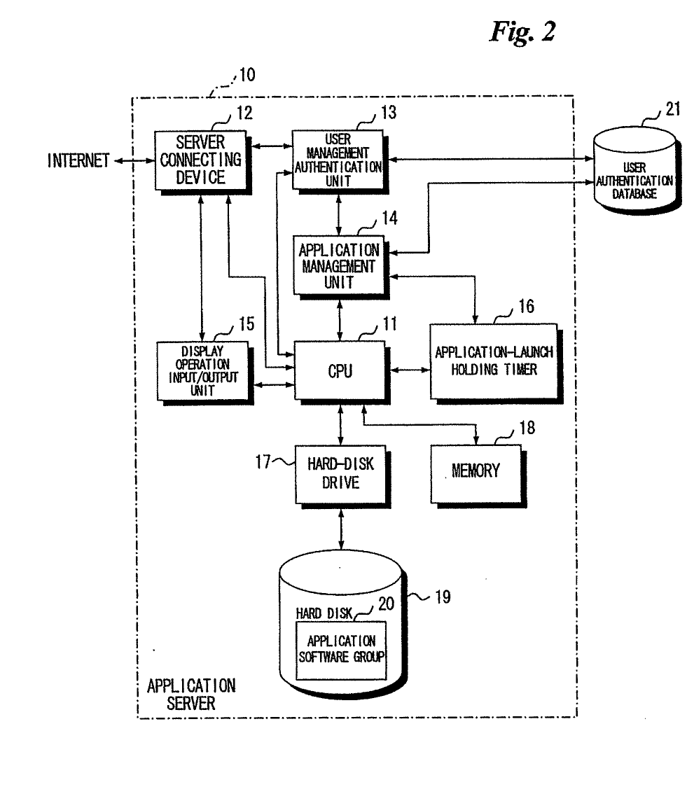

FIG. 2 is a block diagram illustrating the electrical configuration of the application server 10.

The overall operation of the application server 10 is controlled by a CPU 11. A memory 18 storing prescribed data and the like is connected to the CPU 11.

Accommodated within the application server 10 is a hard disk 19 accessible by a hard-disk drive 17. An application software group 20 composed of a plurality of items of application software has been recorded on the hard disk 19. An operation program of the application server 10 is stored in the hard disk 19.

The application server 10 includes a server connecting device 12 for connecting to the Internet and communicating with the mobile telephone 1. Connection and disconnection to and from the mobile telephone 1 also are detected by the server connecting device 12. The application server 10 further includes a user management authentication unit 13 for authenticating whether a user has the right to utilize the application software group 20. If identification data of a user of the mobile telephone 1 that has accessed the application server 10 has been stored in the user authentication database 21, then this user is authenticated by the user management authentication unit 13.

The application server 10 further includes an application management unit 14 for managing the launching, termination and execution, etc., of the applications constituting the application software group 20. The application server 10 further includes a display-device input/output unit 15 for inputting data representing instructions to operate application software in the mobile telephone 1, causing the application software to execute the operation of the application software in the mobile telephone 1 and transmitting image data, which represents an image of the application software, to the mobile telephone 1.

The application server 10 further includes an application-launch holding timer 16. If communication between the mobile telephone 1 and application server 10 is severed, the application-launch holding timer 16 starts timekeeping from the moment of such severance.

Although the user management authentication unit 13, application management unit 14 and display-device input/output unit 15, etc., are implemented by hardware in FIG. 2, these need not necessarily be implemented by hardware and may be implemented by software.

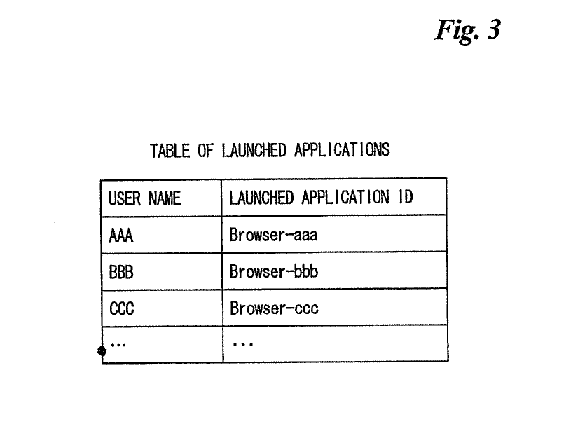

FIG. 3 is an example of a table, which is recorded in the user authentication database 21 (or in a memory 18), indicating applications currently launched. This table of applications currently launched is such that data identifying application software currently launched (IDs of the applications launched) in the application server 10 is stored for every user utilizing the system. For example, it will be understood that application software currently launched (utilized) by a user “AAA” is specified by an application ID “Browser-aaa”. Similarly, with regard to other users as well, items of application software that have been launched by the other users can be determined from this table of currently launched applications.

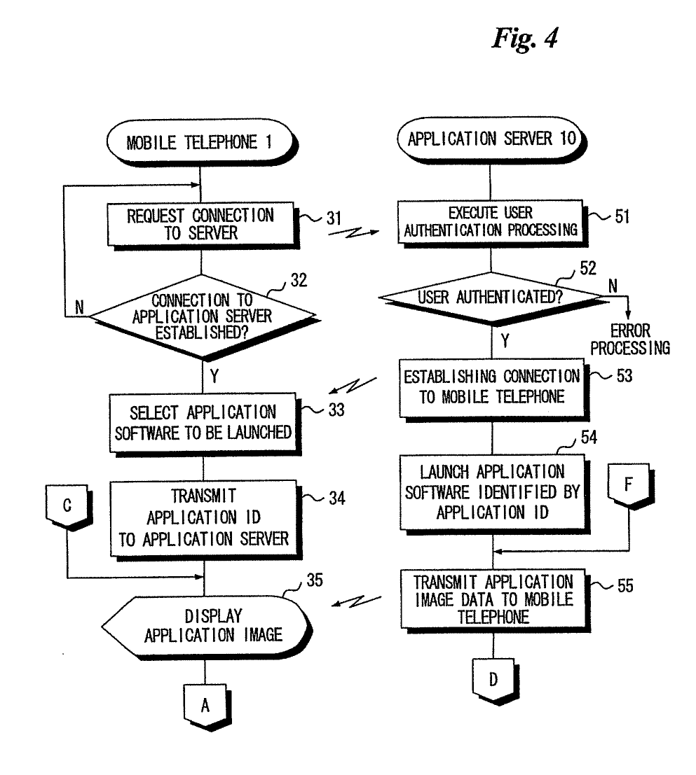

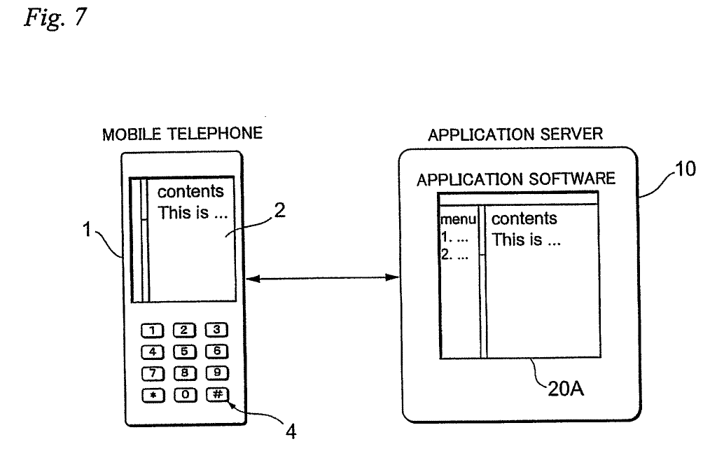

FIGS. 4 to 6 are flowcharts indicating processing by the thin client system. FIGS. 7 to 9A-9C schematically illustrate the relationship between application software that has been launched in the application server 10 and an image of the application software displayed on the display screen of the mobile telephone 1.

With reference to FIG. 7, a display screen 2 is formed on the upper portion of the front side of the mobile telephone 1, and a keypad 4 is formed below the display screen 2.

When the mobile telephone 1 issues a connection request to the application server 10 (step 31 in FIG. 4), the application server 10 executes user authentication processing (step 51 in FIG. 4). In the connection request, the identification data of the mobile telephone 1 (the user) is transmitted from the mobile telephone 1 to the application server 10, and user authentication processing is executed based upon this identification data. If the user is authenticated (“YES” at step 52 in FIG. 4), then a communication connection between the mobile telephone 1 and application server 10 is established (“YES” at step 32 in FIG. 4; step 53 in FIG. 4).

When the mobile telephone 1 and application server 10 are connected for communication, the application software utilized by the user of the mobile telephone 1 is selected using the keypad 4 of the mobile telephone 1 (step 33 in FIG. 4). The names of a plurality of utilizable items of application software are displayed on the display screen 2 of the mobile telephone 1 and the desired application software is selected by choosing the name from among the displayed names. The application ID identifying the selected application software is transmitted from the mobile telephone 1 to the application server 10 (step 34 in FIG. 4).

When the application ID transmitted from the mobile telephone 1 is received at the application server 10, application software 20A identified by this application ID is launched in the application server 10 (step 54 in FIG. 4; FIG. 7). Image data representing the image of the application software 20A launched in the application server 10 is transmitted from the application server 10 to the mobile telephone 1 (step 55 in FIG. 4).

The image of the application software 20A represented by the image data transmitted from the application server 10 is displayed on the display screen 2 of the mobile telephone 1 (step 35 in FIG. 4; FIG. 7).

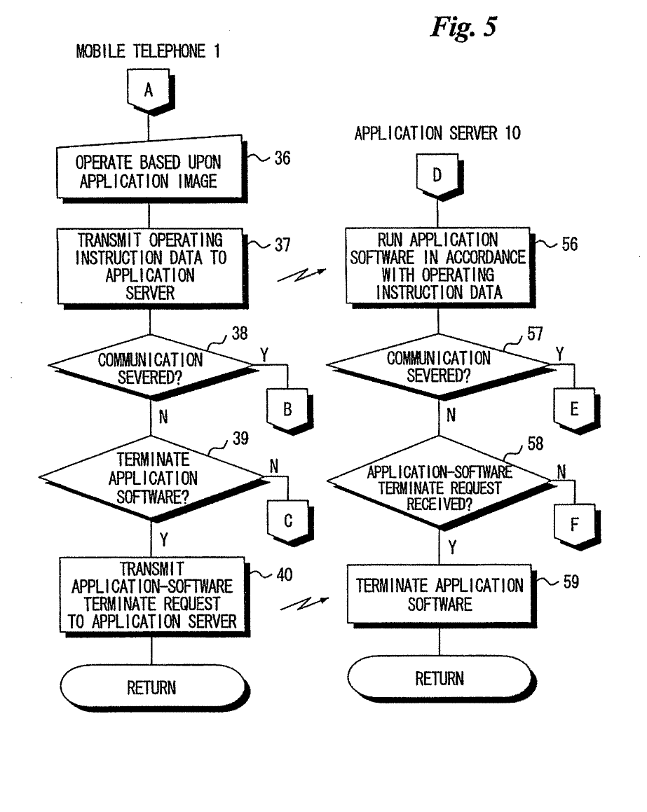

While viewing the image of the application software 20A being displayed on the display screen 2, the user of the mobile telephone 1 issues operating instructions using the keypad 4 (step 36 in FIG. 5). Data representing the operating instructions input to the mobile telephone 1 is transmitted from the mobile telephone 1 to the application server 10 (step 37 in FIG. 5).

When the data representing the operating instructions transmitted from the mobile telephone 1 is received by the application server 10, the application software that has been launched in the application server 10 runs in accordance with the data representing the operating instructions (step 56 in FIG. 5).

Whether communication between the mobile telephone 1 and application server 10 has been severed is checked (steps 38, 57 in FIG. 5). If communication has not been severed (“NO” at steps 38, 57 in FIG. 5), then whether the mobile telephone 1 has sent the application server 10 an application-software terminate request is checked (steps 39, 58 in FIG. 5). If an application-software terminate request is transmitted from the mobile telephone 1 to the application server 10 (“YES” at step 39 in FIG. 5; step 40 in FIG. 5; “YES” at step 58 in FIG. 5), then the application software launched in the application server 10 is terminated in accordance with this terminate request (step 59 in FIG. 5).

If an application-software terminate request has not been transmitted from the mobile telephone 1 to the application server 10 (“NO” at steps 39 and 58 in FIG. 5), then image data indicating the result of processing from running of the application software in accordance with the operating instructions is transmitted from the application server 10 to the mobile telephone 1 (step 55 in FIG. 4). The image indicating the result of processing from running of the application software is displayed on the display screen 2 of the mobile telephone 1 (step 35 in FIG. 4).

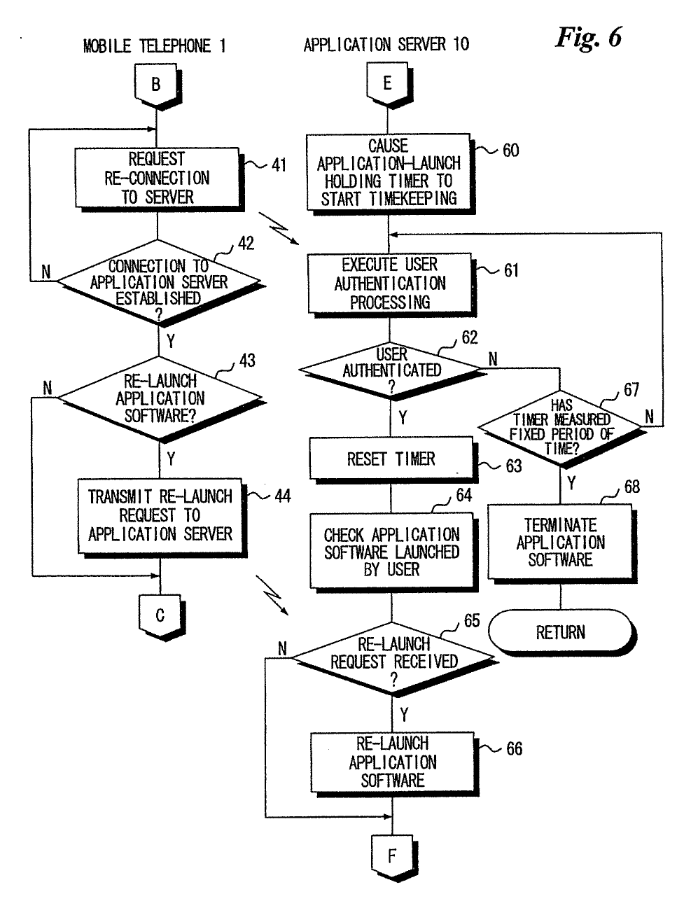

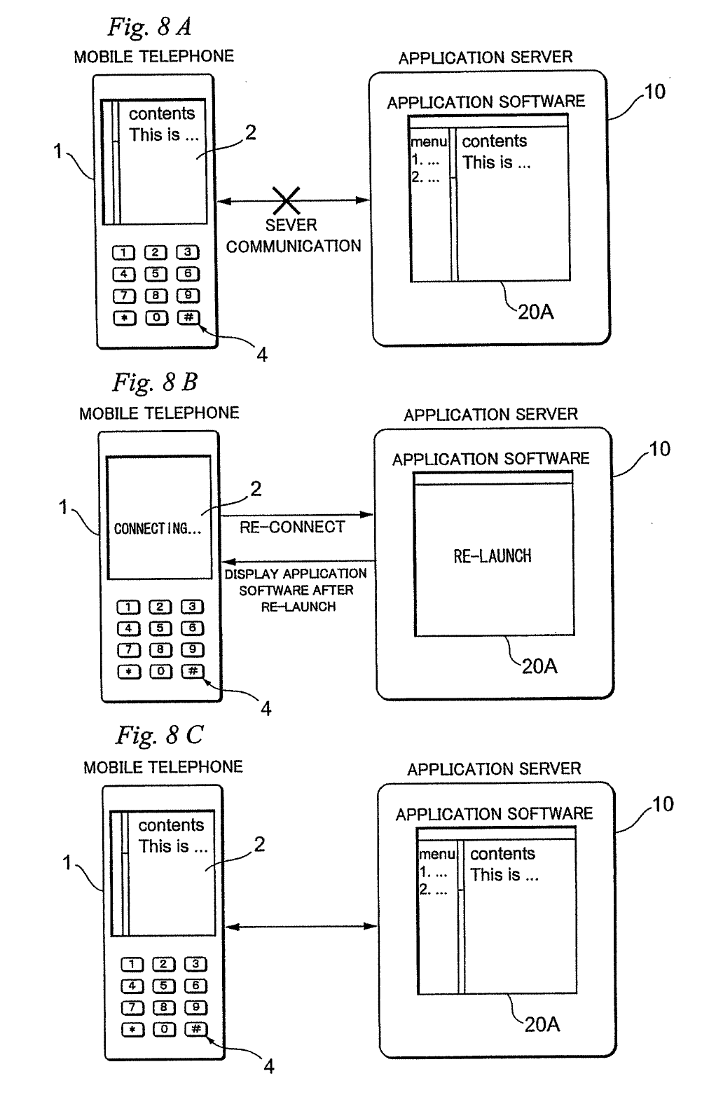

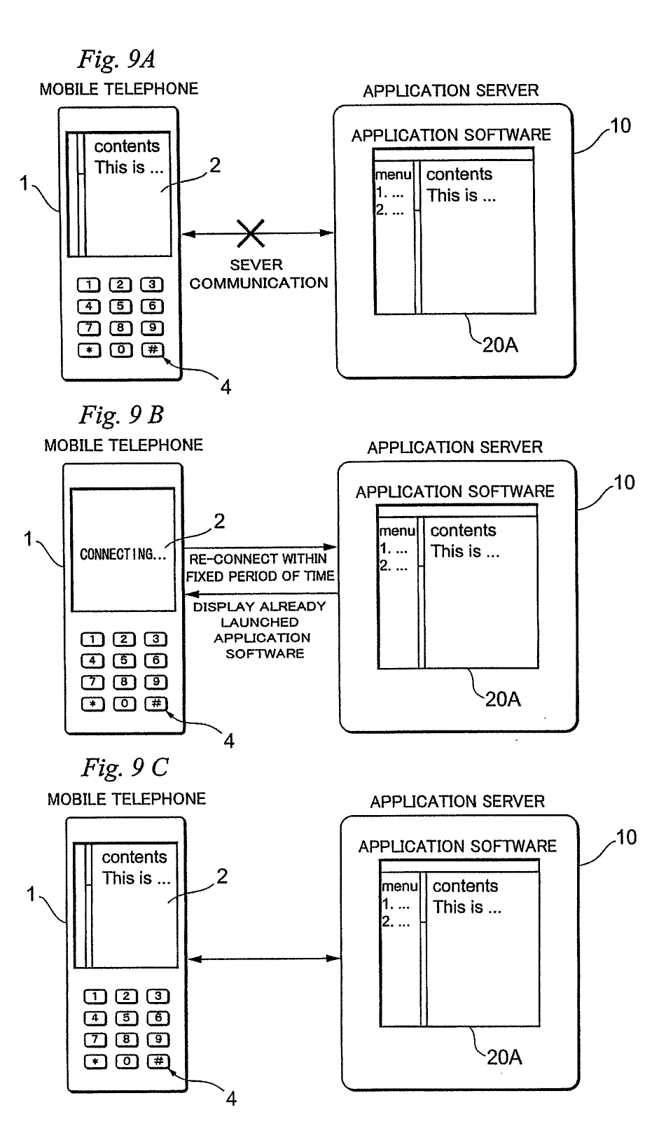

If communication between the mobile telephone 1 and application server 10 is severed (“YES” at steps 38 and 57 in FIG. 5; FIGS. 8A and 9A), then the application-launch holding timer 16 of the application server 10 starts timekeeping (step 60 in FIG. 6).

When the user of the mobile telephone 1 becomes aware of the fact that communication has been severed, the mobile telephone 1 is re-connected to the application server 10 by the user of the mobile telephone 1 (step 41 in FIG. 6). At re-connection, user authentication processing of the mobile telephone 1 is executed (step 61 in FIG. 6). If the user is authenticated (step 62 in FIG. 6) and re-connection between the mobile telephone 1 and application server 10 is established (step 42 in FIG. 6), then the timer 16 is reset (step 63 in FIG. 6). The application server 10 checks the application software launched by the user of the mobile telephone 1 (step 64 in FIG. 6).

Whether the application software that had been launched before severance of communication with the application server 10 is to be re-launched it checked at the mobile telephone 1 by an instruction (input) from the user of the mobile telephone 1 (step 43 in FIG. 6). If the application software is to be re-launched (“YES” at step 43 in FIG. 6), then a re-launch request is transmitted from the mobile telephone 1 to the application server 10 (step 44 in FIG. 6).

If a re-launch request transmitted from the mobile telephone 1 is received at the application server 10 (“YES” at step 65 in FIG. 6), the application software that has been launched is re-launched (step 66 in FIG. 6; FIG. 8B). Image data representing the image of the re-launched application software is transmitted from the application server 10 to the mobile telephone 1 (step 55 in FIG. 4) and the image of the re-launched application software is displayed on the display screen 2 of the mobile telephone 1 (step 35 in FIG. 4; FIG. 8C). The application software re-launched in the application server 10 runs based upon the operating instructions from the mobile telephone 1 in the manner described above (step 56 in FIG. 5).

If a re-launch request is not received at the application server 10 even if a fixed length of time elapses following severance of communication (“NO” at steps 43 and 65 in FIG. 6), then the application software that had been launched in the application server 10 is not re-launched and the image data representing the image of the application software that is being launched is transmitted from the application server 10 to the mobile telephone 1 (step 55 in FIG. 4; FIG. 9B). The image of the application software is again displayed on the display screen 2 of the mobile telephone 1 (step 35 in FIG. 4; FIG. 9C).

If user authentication based upon the re-connect request from the mobile telephone 1 is not performed after severance of communication between the mobile telephone 1 and application server 10 (“NO” at step 62 in FIG. 6), then the timer 16 determines whether the fixed period of time has elapsed following the severance of communication (step 67 in FIG. 6). If the fixed period of time elapses (“YES” at step 67 in FIG. 6), then the application software that has been launched by the user of the mobile telephone 1 is terminated (step 68 in FIG. 6). It goes without saying that in a case where the application server 10 is communicating with a number of mobile telephones and communication is severed, timekeeping by the timer 16 starts from the moment of severance for every mobile telephone whose communication has been severed and whether the fixed period of time has elapsed or not is checked for every mobile telephone. Application software that has been launched in a mobile telephone for which the fixed period of time has elapsed is terminated.

In this embodiment, application software that has been launched is terminated if a fixed period of time elapses following severance of communication. This means that the capability of the application server 10 can be allocated to mobile telephones other than the mobile telephone that was communicating and, hence, that the efficiency of utilization of the application server can be improved.

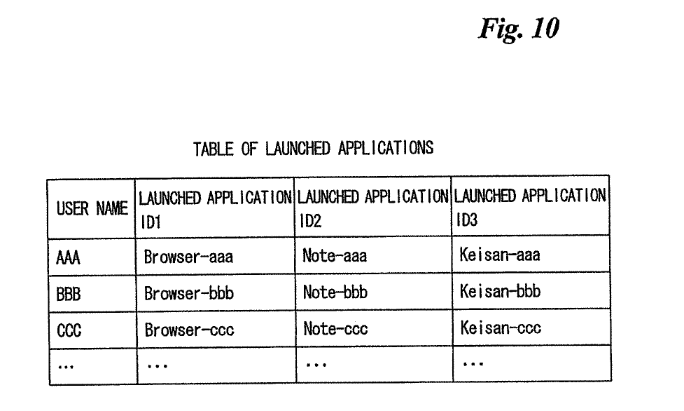

FIGS. 10 to 12 illustrate a modification. This modification is such that a plurality of items of application software are launched by a mobile telephone that communicates with the application server 10.

FIG. 10 illustrates an example of a table of applications currently launched.

Here, for every user of mobile telephones, one or a plurality of application IDs that have been launched in the application server 10 by each of the users using their respective mobile telephones have been stored. For example, it will be understood that user “AAA” has launched application software identified by application ID “Browser-aaa”, application software identified by application ID “Note-aaa” and application software identified by application ID “Keisan-aaa”.

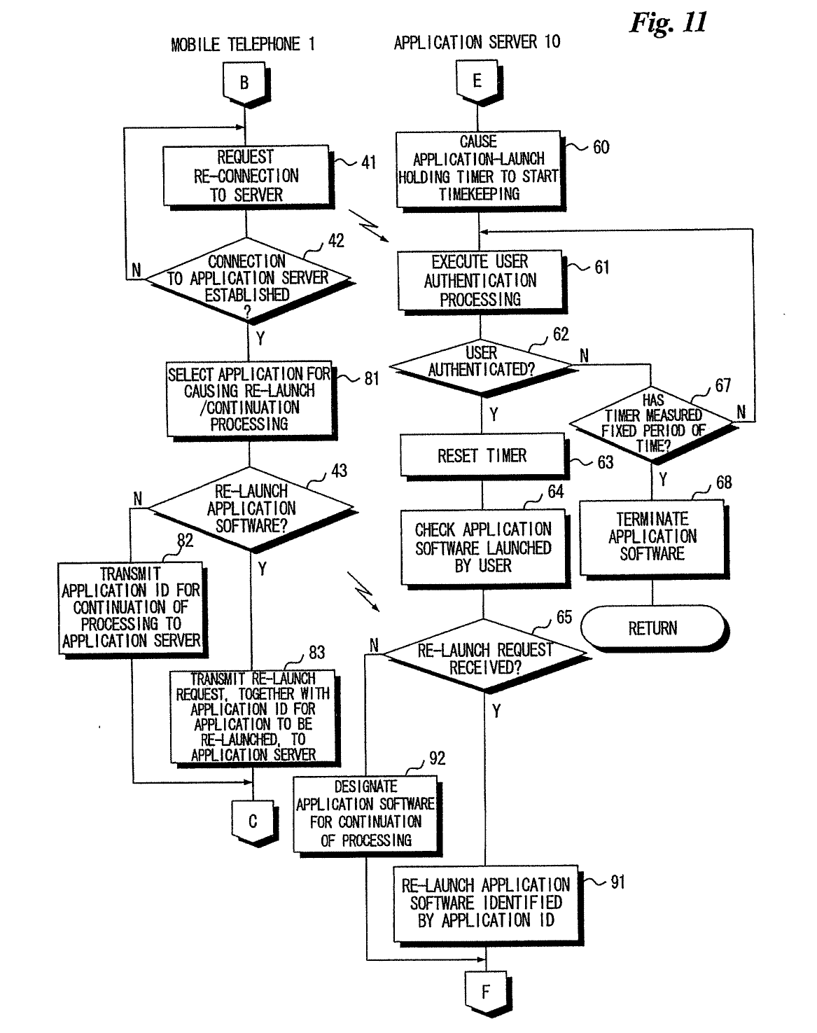

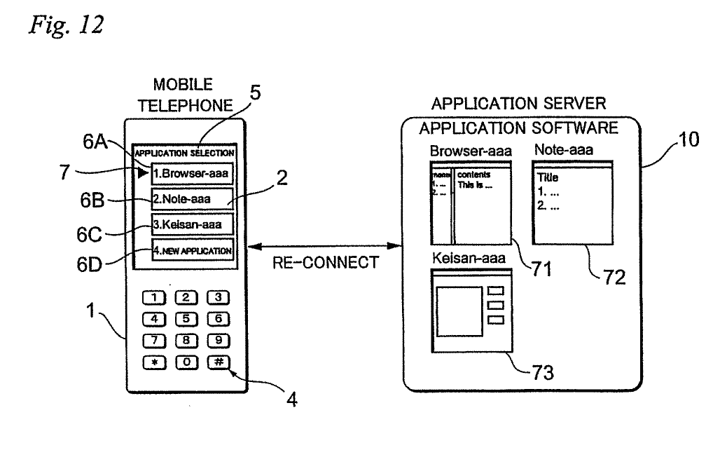

FIG. 11 is a flowchart showing a portion of processing executed by this thin client system. This flowchart corresponds to the flowchart shown in FIG. 6. Processing steps in FIG. 11 identical with those shown in FIG. 6 are designated by like step numbers. FIG. 12 schematically illustrates the relationship between application software that has been launched in the application server 10 and an image of the application software displayed on the display screen of the mobile telephone 1.

When a connection is established by re-connection after establishment of communication, a menu image 5 for selecting the application software that had been launched prior to the severance of communication is displayed on the display screen 2 of the mobile telephone 1, as described above. Application software for performing re-launch or continuation processing (the latter is processing which utilizes the application software that had been launched before severance of communication, without performing re-launch as described above) is selected using the menu image 5 (step 81 in FIG. 11).

With reference to FIG. 12, it is assumed that the application server 10 has launched the application software identified by application ID “Browser-aaa”, the application software identified by application ID “Note-aaa” and the application software identified by application ID “Keisan-aaa”. In this case, the menu image 5 on the display screen 2 of the mobile telephone 1 displays areas 6A, 6B and 6C, in which appear the names of the respective items of application software identified by the application ID “Browser-aaa”, application software identified by the application ID “Note-aaa” and application software identified by the application ID “Keisan-aaa”, which have been launched in the mobile telephone 1, and an area 6D in which the character string of a new application appears. A cursor 7 moved freely up and down by the keypad 4 of the mobile telephone 1 is displayed on the left side of these areas 6A to 6D.

If a decision button that has been assigned to a prescribed button included in the keypad 4 of mobile telephone 1 is pressed, the application software whose name appears in the area on the right side where the cursor 7 is situated will be selected from among the areas 6A to 6D. If the area 6D is selected, the new application software will be selected.

In a case where application software is to be re-launched (“YES” at step 43) (a button for designating re-launch or continuation processing would be assigned to a button of the keypad 4), the application ID of the application software specified by the area selected from among the areas 6A to 6C is transmitted together with a re-launch request from the mobile telephone 1 to the application server 10 (step 83).

If a re-launch request and application ID transmitted from the mobile telephone 1 are received by the application server 10 (“YES” at step 65), then the application software identified by the application ID is re-launched (step 91). Processing from this point onward is similar to that described above.

In a case where application software is not re-launched (“NO” at step 43), application software for which processing is to continue is specified by the area selected from among the areas 6A to 6C. The application ID for which processing is to continue is transmitted from the mobile telephone 1 to the application server 10 (step 82).

When the application ID for which processing is to continue is received by the application server 10, the application software currently launched and whose processing is to continue is specified by this application ID (step 92). Image data representing the image of the specified application software is not re-launched; rather, the image of this application software is transmitted from the application server 10 to the mobile telephone 1.

It goes without saying that application software selected by the menu image 5 is not limited to a single item of application software; several items of software currently launched can be selected. Further, if the area 6D of the new application is selected in the menu image 5, then a list of items of application software capable of being launched anew will be transmitted from the application server 10 to the mobile telephone 1 and application software can be selected from the list. Application software thus selected can be launched and processed in the application server 10 in the manner described above.

As many apparently widely different embodiments of the present invention can be made without departing from the spirit and scope thereof, it is to be understood that the invention is not limited to the specific embodiments thereof except as defined in the appended claims.

What is claimed is:

1. An application server which is capable of communicating with a number of mobile terminals and in which application software has been installed, said application server comprising:
a launching device, responsive to an application-software launch request transmitted from one mobile terminal among the number of mobile terminals, for launching application software whose launch has been requested;
an image data transmitting device for transmitting image data, which represents an image of the application software launched by said launching device, to the one mobile terminal;
an application software control device for controlling the application software, which has been launched by said launching device, so as to operate in accordance with application-software operating instruction data transmitted from the one mobile terminal owing to receipt at the mobile terminal of the image data transmitted from said image data transmitting device;
a transmission control device for controlling said image data transmitting device in such a manner that image data representing the image of the application software controlled by said application software control device is transmitted to the one mobile terminal;
a disconnect determination device for determining whether communication with the one mobile terminal has been severed; and
a time-expiration determination device for determining whether a fixed period of time has expired from a moment at which said disconnect determination device determines that communication with the one mobile terminal has been severed;
wherein in response to a determination by said time-expiration determination device that the fixed period of time has expired, said application software control device terminates the application software launched by said launching device.

2. The server according to claim 1, wherein in response to re-connection of the one mobile terminal and the application server before the fixed period of time expires from the moment at which said disconnect determination device determines that communication with the one mobile terminal has been severed, said image data transmitting device transmits the image data, which represents the image of the application software that has been launched by said launching device, to the one mobile terminal.

3. The server according to claim 1, wherein in response to re-connection of the one mobile terminal and the application server and to issuance of a re-transmit request for the image data, which represents the image of the application software that has been launched by said launching device, before the fixed period of time expires from the moment at which said disconnect determination device determines that communication with the one mobile terminal has been severed, said image data transmitting device transmits the image data, which represents the image of the application software that has been launched by said launching device, to the one mobile terminal, and in response to re-connection of the one mobile terminal and the application server and to issuance of a re-launch request for the application software that has been launched by said launching device, before the fixed length of time expires from the moment at which said disconnect determination device determines that communication with the one mobile terminal has been severed, said image data transmitting device re-launches the application software that has been launched by said launching device and transmits the image data, which represents the image of the re-launched application software, to the one mobile terminal.

4. The server according to claim 1, wherein said launching device launches a plurality of items of application software in response to launch requests, which have been transmitted from the one mobile terminal, for the plurality of items of application software;
said image data transmitting device transmits image data, which represents images of the plurality of items of application software launched by said launching device, to the one mobile terminal;
said application software control device controls application software, which has been operated at the one mobile terminal, among the items of application software that have been launched by said launching device, so as to operate in accordance with identification data, which identifies the application software operated at the one mobile terminal among the plurality of items of application software, and with operating instruction data, which instructs operation of the operated application software, transmitted from the one mobile terminal owing to receipt at the mobile terminal of the image data transmitted from said image data transmitting device; and
in response to re-connection of the one mobile terminal and the application server and to issuance of a re-transmit request for the image data, which represents the image of prescribed application software among the plurality of items of application software, before the fixed period of time expires from the moment at which said disconnect determination device determines that communication with the one mobile terminal has been severed, said image data transmitting device transmits the image data, which represents the image of the prescribed application software among the images of application software that have been launched by said launching device, to the one mobile terminal.

5. A method of controlling operation of an application server which is capable of communicating with a number of mobile terminals and in which application software has been installed, said method comprising the steps of:
launching application software, whose launch has been requested, in response to an application-software launch request transmitted from one mobile terminal among the number of mobile terminals;
transmitting image data, which represents an image of the application software launched, to the one mobile terminal;
controlling the application software, which has been launched, so as to operate in accordance with application-software operating instruction data transmitted from the one mobile terminal owing to receipt at the mobile terminal of the image data transmitted;
exercising control in such a manner that image data representing the image of the application software controlled is transmitted to the one mobile terminal;
determining whether communication with the one mobile terminal has been severed;
determining whether a fixed period of time has expired from a moment at which severance of communication with the one mobile terminal has been determined; and
terminating the launched application software in response to a determination that the fixed length of time has expired.

6. A recording medium storing a computer-readable program for controlling operation of an application server which is capable of communicating with a number of mobile terminals and in which application software has been installed, said program controlling operation of the application software so as to:
launch application software, whose launch has been requested, in response to an application-software launch request transmitted from one mobile terminal among the number of mobile terminals;
transmit image data, which represents an image of the application software launched, to the one mobile terminal;
control the application software, which has been launched, so as to operate in accordance with application-software operating instruction data transmitted from the one mobile terminal owing to receipt at the mobile terminal of the image data transmitted;
transmit image data representing the image of the controlled application software to the one mobile terminal;
determine whether communication with the one mobile terminal has been severed;
determine whether a fixed period of time has expired from a moment at which severance of communication with the one mobile terminal has been determined; and
terminate the launched application software in response to a determination that the fixed length of time has expired.
